(19) United States
(12) Patent Application Publication
(10) Pub. No.: US 2023/0138610 A1
(43) Pub. Date: May 4, 2023

(54) Customizing Operational Design Domain of an Autonomous Driving System for a Vehicle Based on Driver's Behavior

(71) Applicant: Robert Bosch GmbH, Stuttgart (DE)

(72) Inventor: Mahesh Sarode, Farmington, MI (US)

(21) Appl. No.: 17/517,393

(22) Filed: Nov. 2, 2021

(51) Int. Cl. B60W 60/00

(52) U.S. Cl. CPC B60W 60/0051; B60W 2540/30; B60W 2555/20; B60W 2552/05; B60W 2554/40; B60W 2720/10; B60W 2720/12

(57) ABSTRACT

An autonomous vehicle driving system for autonomously controlling a vehicle. The system includes an environment detection system, a memory including an operational domain definition, and an electronic processor. The electronic processor is configured to detect a behavioral characteristic of a driver of the vehicle, the behavioral characteristic corresponding to a current driving scenario, determine, via the environment detection system, the current driving scenario in response to detecting the behavioral characteristic, and adjust the operational domain definition based on the determined current driving scenario.

### FIELD

Embodiments relate to improving the operation of autonomous vehicles, for example, when such vehicles are operating in environments where human-driven vehicles also operate.

### BACKGROUND

Modern vehicles include various partially autonomous driving functions, for example adaptive cruise-control, collision avoidance systems, self-parking, and the like. Fully autonomous driving is a goal, but has not yet been achieved, at least on market-ready, commercially-viable scale.

### SUMMARY

Autonomous vehicles are limited to operating autonomously within a certain operational design domain (ODD). The ODD is defined by one or more parameters that an electronic processor is trained to operate an autonomous driving system of a vehicle with a predetermined level of confidence. While a current approach to creating an ODD may be based on system limitations, safety, and an average user reaction, such methods of ODD design often fail to identify corner cases where an individual user prefers that the autonomous driving system take control of the vehicle. For example, some users may prefer driving in a curve slower than other drivers and will resort to turning control of the vehicle over to the autonomous driving system.

Accordingly, systems and methods are provided herein for, among other things, a custom operational design domain of an autonomous driving system for a vehicle based on a driver's behavior.

For example, one embodiment provides an autonomous vehicle driving system for autonomously controlling a vehicle. The system includes an environment detection system, a memory including an operational domain definition, and an electronic processor. The electronic processor is configured to detect a behavioral characteristic of a driver of the vehicle, the behavioral characteristic corresponding to a current driving scenario, and determine, via the environment detection system, the current driving scenario in response to detecting the behavioral characteristic. The electronic processor is further configured to adjust the operational domain definition based on the determined current driving scenario.

Another embodiment provides a method for operating a vehicle including an autonomous driving system. The method includes detecting a behavioral characteristic of a driver of the vehicle, the behavioral characteristic corresponding to a current driving scenario, and determining, via an environment detection system, the current driving scenario in response to detecting the behavioral characteristic. The method also includes adjusting an operational domain definition of the system based on the determined current driving scenario.

Other aspects, features, and embodiments will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an autonomous driving system for controlling a vehicle in accordance to some embodiments.

FIG. 2 is a block diagram of an electronic controller of the autonomous driving system of FIG. 1 in accordance to some embodiments.

FIG. 3 is a flowchart of a method of operating the vehicle including the autonomous driving system of FIG. 1 in accordance to some embodiments.

FIG. 4 is an illustration of a driving scenario of the vehicle of FIG. 1 in accordance to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments illustrated.

The apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION

Before any embodiments are explained in detail, it is to be understood that this disclosure is not intended to be limited in its application to the details of construction and the arrangement of components set forth in the following description or illustrated in the following drawings. Embodiments are capable of other configurations and of being practiced or of being carried out in various ways. For example, while embodiments are described herein in terms of a fully autonomous driving system, the disclosed system and methods may be applied to partially autonomous driving systems.

A plurality of hardware and software based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more communication interfaces, one or more application specific integrated circuits (ASICs), and various connections (for example, a system bus) connecting the various components. Regardless of how they are combined or divided, hardware and software components may be located on the same computing device or may be distributed among different computing devices connected by one or more networks or other suitable communication links.

For ease of description, some of the example systems presented herein are illustrated with a single exemplar of each of its component parts. Some examples may not describe or illustrate all components of the systems. Other embodiments may include more or fewer of each of the illustrated components, may combine some components, or may include additional or alternative components.

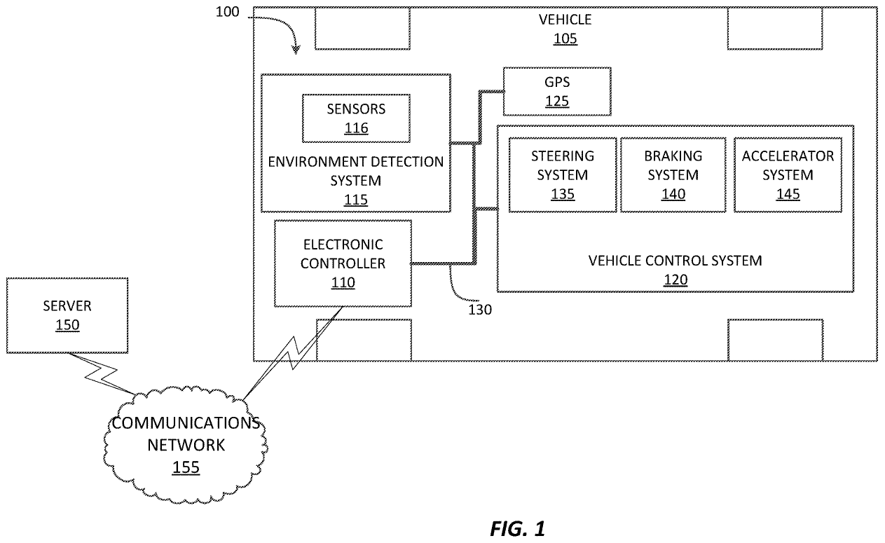

FIG. 1 illustrates an autonomous driving system 100 for controlling a vehicle 105. The vehicle 105, although illustrated as a four-wheeled vehicle, may encompass various types and designs of vehicles. For example, the vehicle 105 may be an automobile, motorcycle, truck, bus, semi-tractor, a combination of the foregoing, or the like.

The autonomous driving system 100 includes an electronic controller 110 and an environment detection system 115, both of which are communicatively coupled to a vehicle control system 120 and a global positioning system (GPS) 125 of the vehicle 105. The systems, for example, the electronic controller 110, the environment detection system 115, the vehicle control system 120, GPS 125, and other various modules and components of the vehicle 105, are electrically coupled or connected to each other by or through one or more control or data buses (for example, the bus 130), which enable communication therebetween. The use of control and data buses for the interconnection between, and communication among, the various modules and components would be known to a person skilled in the art in view of the invention described herein. In some embodiments, the bus 130 is a Controller Area Network (CAN™) bus. In some embodiments, the bus 130 is an automotive Ethernet, a FlexRay™ communications bus, or another suitable wired bus. In alternative embodiments, some or all of the components of the vehicle 105 may be communicatively connected using suitable wireless modalities (for example, Bluetooth™ or another kind of near field communication).

The embodiment illustrated in FIG. 1 provides but one example of the components and connections of the autonomous driving system 100 and the vehicle 105. Thus, the components and connections of the system 100 and vehicle 105 may be constructed in other ways than those illustrated and described herein. It should also be understood that the system 100 and/or vehicle 105 may include fewer or additional components than those illustrated in FIG. 1.

The electronic controller 110 is configured to receive sensor information from the environment detection system 115 to implement an autonomous driving operation. The electronic controller 110 accordingly drives (controls) the vehicle 100 based on the information from the environment detection system 115 by transmitting one or more commands to the vehicle control system 115. The electronic controller 110 may automatically activate the autonomous driving operation automatically or in response to a user input.

The environment detection system 115 includes, among other things, one or more sensors 116 for determining one or more attributes of the vehicle 105 and its surrounding environment. The environment detection system 115 transmits information regarding those attributes to the electronic controller 110. Such information may also be transmitted to one or more of the other systems of the vehicle 105 (for example, the vehicle control system). The sensors 116 may include, for example, vehicle control sensors (for example, sensors that detect accelerator pedal position, brake pedal position, and steering wheel position), wheel speed sensors, vehicle speed sensors, yaw sensors, force sensors, odometry sensors, and vehicle proximity sensors (for example, camera, radar, LIDAR, and ultrasonic sensors). In some embodiments, the sensors 116 include one or more cameras configured to capture one or more images of the environment surrounding and/or within the vehicle 105 according to their respective fields of view. The environment detection system 115 may include multiple types of imaging devices/sensors, each of which may be located at different positions on the interior or exterior of the vehicle 105. For example, one or more of the sensors 116, or components thereof, may be externally mounted to a portion of the vehicle 105 (such as on a side mirror or a trunk door) or may be internally mounted within the vehicle 105 (for example, positioned by the rearview mirror. The sensors 116 of the environment detection system 115 are also configured to receive signals indicative of the vehicle's distance from and position relative to, elements in the surrounding environment of the vehicle 105 as the vehicle 105 moves from one point to another. The sensors 116 may include one or more sensors of one or more other systems of the vehicle 105, which are not shown.

The vehicle control system 120 includes components involved in the autonomous or manual control of the vehicle 105. For example, in some embodiments, the vehicle control system 120 includes a steering system 135, a braking system 145, and an accelerator system 150. The systems 135, 145, 150 each include mechanical and electrical components for implementing steering, braking, and acceleration of the vehicle 105 respectively. The embodiment illustrated in FIG. 1 provides but one example of the components of the vehicle control system 115. In other embodiments, the vehicle control system 120 includes additional, fewer, or different components.

In some embodiments, the autonomous driving system 100 is also communicatively coupled to a server 155 via a communications network 150. The communications network 160 may be implemented using a wide area network (for example, the Internet), a local area network (for example, an Ethernet or Wi-Fi™ network), a cellular data network (for example, a Long Term Evolution (LTE™) network), and combinations or derivatives thereof. In some embodiments, the autonomous driving system 100 and the server 150 communicate through one or more intermediary devices, such as routers, gateways, or the like (not illustrated).

In the embodiment illustrated in FIG. 1, the server 135 includes one or more databases or is able to access one or more remote databases via the communications network 140. The one or more databases include map data, for example, roadway data, current weather data for one or more locations, and/or construction data for one or more roadways.

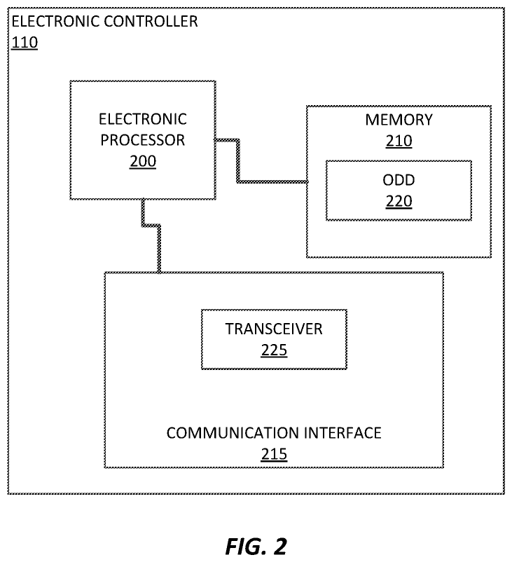

FIG. 2 is a block diagram of one example embodiment of the electronic controller 110 included in the vehicle 105 of FIG. 1. The electronic controller 110 includes a plurality of electrical and electronic components that provide power, operation control, and protection to the components and modules within the electronic controller 110. The electronic controller 110 includes, among other things, an electronic processor 200 (such as a programmable electronic microprocessor, microcontroller, or similar device), a memory 205, and a communication interface 210. The electronic processor 200 is communicatively coupled to the memory 205 and the communication interface 210. The electronic processor 200, in coordination with the memory 205 and the communication interface 210, is configured to implement, among other things, the methods described herein. The electronic controller 110 may be implemented in several independent controllers (for example, programmable electronic controllers) each configured to perform specific functions or sub-functions. Additionally, the electronic controller 110 may contain sub-modules that include additional electronic processors, memory, or application specific integrated circuits (ASICs) for handling communication functions, processing of signals, and application of the methods listed below. In other embodiments, the electronic controller 110 includes additional, fewer, or different components.

The memory 205 may be made up of one or more non-transitory computer-readable media and includes at least a program storage area and a data storage area. The program storage area and the data storage area can include combinations of different types of memory, such as read-only memory (“ROM”), random access memory (“RAM”) (for example, dynamic RAM (“DRAM”), synchronous DRAM (“SDRAM”), etc.), electrically erasable programmable read-only memory (“EEPROM”), flash memory, or other suitable memory devices.

The memory 210 includes an ODD 220. The ODD 220 is a plurality of parameters that defines where and when the autonomous driving system 100 can and cannot take control of the vehicle 105. The ODD 220, for example, defines the specific operating domains in which autonomous driving of the vehicle 105 (or an autonomous feature thereof) is designed to properly operate. While each domain is subject to potential definition, the ODD 220 provides at least a general description of the domains that have been accounted for in designing the vehicle 105 or features operation. The domains specify, for example, roadway types, speed range, environmental conditions (weather, daytime/nighttime, etc.), road and lane geometry, infrastructure state (state of pavement), particular geo-location, and other domain constraints. For example, in embodiments where the vehicle 105 is a front-wheel drive, four-door passenger vehicle, the ODD 220 may specify the following domains: paved roads, speeds from zero to 110 miles per hour, rain, daytime, and nighttime. As another example, in embodiments where the vehicle 105 is a four-wheel drive, pickup truck, the ODD 220 may specify the following domains: paved roads, non-roads with obstacles shorter than 12 inches, speeds of zero to 90 miles per hours, rain, snow, mud, daytime, and nighttime. When the vehicle 105 is operating in a situation that is within the ODD 220, the autonomous driving system 100 may prompt the driver as to whether the driver would like for the autonomous driving system 100 to take control of the vehicle 105. As explained in more detail below, the electronic processor 200 may modify one or more parameters of the ODD 220 based on a current driving scenario.

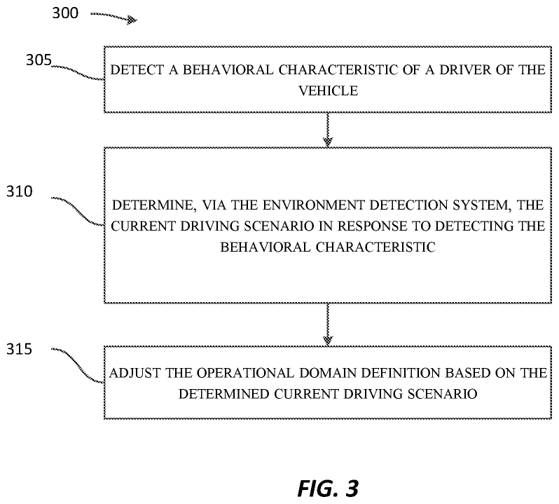

In some embodiments, at least a portion of data of the memory 205 may be stored at a storage outside of the electronic controller 110 (for example, at the server 150). The memory 205 of the electronic controller 110 includes software that, when executed by the electronic processor 200, causes the electronic processor 200 to perform the example method 300 illustrated in FIG. 3.

The communication interface 215 transmits and receives information from devices external to the electronic controller 110 over one or more wired and/or wireless connections, for example, components of the vehicle 105 via the bus 130. The communication interface 210 receives user input, provides system output, or a combination of both. The communication interface 210 may be configured to receive, for example, a request from a driver of the vehicle 105 to engage (and/or disengage) an autonomous driving operation of the vehicle 105 implemented by the electronic controller 110. The communication interface 210 may be communicatively coupled to and exchange information with one or more user input devices (for example, keypad, touch-sensitive surface, button, a microphone, an imaging device, and/or another input device). The communication interface 210 may also be communicatively coupled to one or more user output devices such as a speaker, an electronic display screen (which, in some embodiments, may be a touch screen and thus also acts as an input device), and the like. One or more of the user input and/or user output devices may be integrated into the vehicle 105 (for example, some of the components may be part of a head unit of the vehicle 105, which is not shown). The communication interface 210 includes, in some embodiments, a transceiver 220. The electronic controller 110 may utilize the transceiver 225 communicate wirelessly with other devices within and/or outside of the vehicle 105 (for example, the server 150). The communication interface 210 may also include other input and output mechanisms, which for brevity are not described herein and which may be implemented in hardware, software, or a combination of both.

It should be understood that although FIG. 2 illustrates only a single electronic processor 200, memory 205, and communication interface 210, alternative embodiments of the electronic controller 110 may include multiple processing units, memory modules, and/or input/output interfaces. It should also be noted that the vehicle 105 may include other electronic controllers, each including similar components as, and configured similarly to, the electronic controller 110. In some embodiments, the electronic controller 110 is implemented partially or entirely on a semiconductor (for example, a field-programmable gate array [“FPGA”] semiconductor) chip. Similarly, the various modules and control units described herein may be implemented as individual controllers, as illustrated, or as components of a single controller. In some embodiments, a combination of approaches may be used.

FIG. 3 illustrates an example of a method 300 operating the vehicle 105 including the autonomous driving system 100. As an example, the method 300 is explained in terms of the electronic controller 110, in particular the electronic processor 200. However, portions of the method 300 may be distributed among multiple devices (for example, one or more additional control units/controllers/processors of or connected to the vehicle 105).

At step 305, the electronic processor 200 detects a behavioral characteristic of a driver of the vehicle 105, the behavioral characteristic corresponding to a current driving scenario. The behavioral characteristic may be an action made by the driver of the vehicle 105 in response to a current driving situation (for example, a response made when the driver perceives the driving scenario to be tricky or stressful). In one example, the behavioral characteristic is a facial expression of the driver. In some embodiments, the behavioral characteristic is the driver inputting a request for the autonomous driving system 100 to autonomously control the vehicle 105. The behavioral characteristic may be an adjustment of a speed of the vehicle 105. The behavioral characteristic may be detected via the one or more sensors 116 of the environment detection system 115. In one example, a facial expression of the driver is detected via facial recognition performed by the electronic processor 200 on an image captured by a camera within the vehicle 105 and a speed adjustment is determined via a brake pedal sensor and/or odometer of the vehicle 105. In some embodiments, the environment detection system 115 utilizes information from the GPS 125 and/or map data from the server in determining the current driving scenario.

A current driving scenario of the vehicle 105 is a present environmental situation including one or more particular features. For example, a feature may be a location, a time of day (a particular time or whether day or night), a weather condition (for example, raining, foggy, snowing, etc.), a traffic situation, a road condition, and the like. The driving scenario may be a parking scenario (when attempting to park the vehicle 105) or a traffic scenario (when actively driving the vehicle 105 somewhere). A location of the current driving scenario may be a general type of location (for example, a rural location, a suburb, a city, a construction zone, a residential area, a freeway, etc.) or a particular location (for example, a certain road or part thereof). A traffic situation may be a general level of traffic on the road that the vehicle 105 is on or a particular positioning of one or more other vehicles surrounding the vehicle 105 (for example, another vehicle is in a blind spot behind the vehicle 105). A road condition may be any feature of the road that the vehicle 105 is currently on. The road condition may be, for example, the type of road (dirt, gravel, snowy, icy, paved, etc.), a quality of the road (for example, whether the road is bumpy or smooth), a particular speed limit of the road, a degree of curvature of the road, and the like.

At block 310, the electronic processor 200 determines, via the environment detection system 115, the current driving scenario in response to detecting the behavioral characteristic and, at block 315, adjusts the ODD 220 based on the determined driving scenario. The electronic processor 200 may, in particular, identify one or more particular features of the current driving scenario and adjust the ODD 220 based on the identified feature(s). In one example, the electronic processor 200 alters the ODD 220 by adjusting one or more parameters (for example, confidence levels or weights) according to the current driving scenario (or features thereof) or similar driving scenarios (for example, driving scenarios including one or more similar features as those identified in the current driving scenario) or features. The ODD 220 may be adjusted (for example, over time) such that eventually the driver of the vehicle 105 will be prompted as to whether or not to allow the autonomous driving system 100 to take control of the vehicle 105 (or the autonomous driving system 100 will automatically take control of the vehicle 105) when the system 100 determines that the vehicle 105 is currently in a similar driving scenario.

The electronic processor 200 may, for example, implement one or more types of machine learning and/or pattern recognition processes to learn which driving scenarios (and/or features thereof) that the driver desires (or, in some embodiments, does not desire) that the autonomous driving system 100 take control of the vehicle 105 and adjust the ODD 220 accordingly.

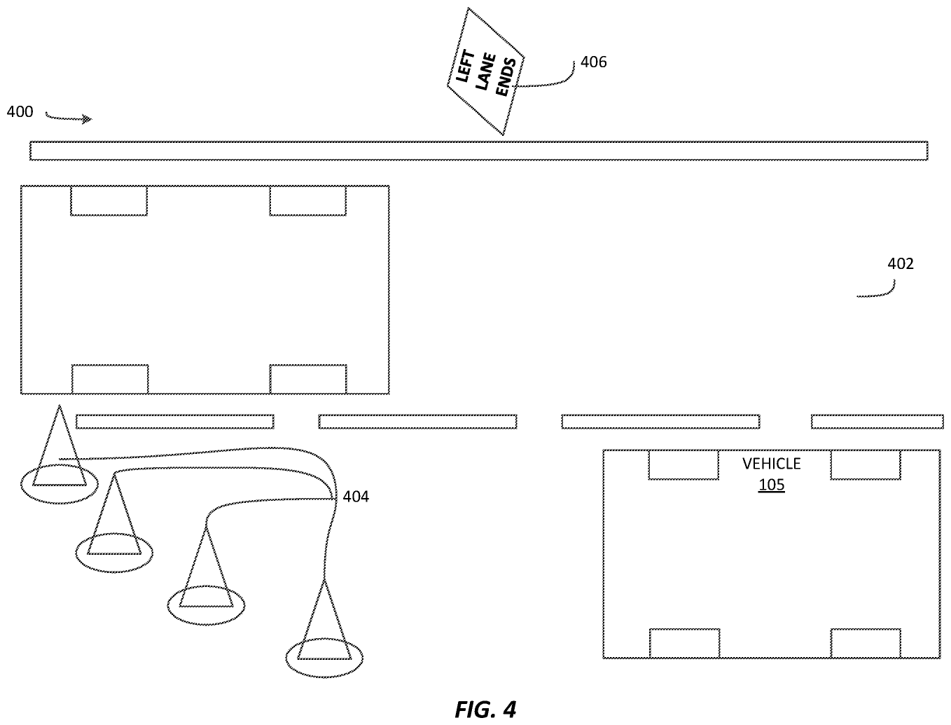

FIG. 4 illustrates an example of a driving scenario 400 of the vehicle 105. In the illustrated example, the driving scenario 400 is that where the vehicle 105 is entering a construction zone and must merge to the left lane 402. In this example, the electronic controller 110 detects that the driver of the vehicle 105 desires the autonomous driving system 100 to take control of the vehicle 105, for example, upon detecting a request for the system 100 to take over. The vehicle then determines the driving scenario, for example, by identifying one or more features via the one or more sensors 116 of the environment detection system 115. For example, the electronic controller 110 via a camera of vehicle 105, captures an image that includes one or more traffic cones 404 and a construction sign 406. Using the image captured by the camera, the electronic processor 200 determines that the vehicle 105 is entering a construction zone. For example, the electronic processor 200 may utilize a computer vision algorithm such as a convolutional neural network (CNN) to recognize the one or more traffic cones 404 and construction sign 406. Based on the one or more traffic cones 404 and the construction sign 406 included in the surrounding environment, electronic processor 200 determines that the vehicle 105 is entering a construction zone and a that a construction zone may be defined as a type of driving scenario that may be placed within the ODD 220 of the vehicle 105. In some embodiments, the electronic processor 200 calculates a confidence level to determine whether the current driving scenario should be placed within the ODD 220. In one example, the electronic processor 200 uses historic data regarding previously detected driving scenarios (and/or features thereof) and the corresponding behavioral characteristics to calculate a confidence level for the current driving scenario of the vehicle 105 regarding whether or not to prompt the driver to take control of the vehicle 105.

It should be understood that, while the method 300 is generally described in terms of identifying driving scenarios where a driver would prefer that the vehicle 105 be autonomously driven via the system 100, the method 300 may also be applied to identify driving scenarios where the driver would prefer to manually control the vehicle 105 without intervention of the autonomous driving system 100. For example, the system 100 may perform steps 310-315 of the method 300 of FIG. 3 in response to detecting that the driver has discontinued an autonomous driving operation performed by the system 100 and adjust the ODD 220 such that the system 100 may eventually not offer to perform an autonomous drive operation to the driver in similar subsequent driving scenarios.

In some embodiments, the autonomous driving system 100 is configured to share its ODD 220 or certain information related to the ODD 220 (for example, one or more features of certain driving scenarios where the driver likely wants the autonomous driving system 100 to take control of the vehicle 105) with other devices/systems. In one example, the autonomous driving system 100 shares information related to the ODD 220 with other autonomous driving systems of other vehicles (not shown), for example, over the communication network 155. The information from the system 100 (as well as from the other autonomous driving systems of other vehicles) is stored at a remote server (for example, the server 150). The information may be analyzed (for example, via the electronic processor 200, or a separate remote electronic processor) to identify particular driving scenarios where a majority of individual drivers prefer that their vehicle be autonomously driven rather than manually driven. The ODD 220 of the autonomous driving system 100 and the ODDs of other vehicles of the network 155, may be adjusted based on the information. For example, if the ODD data collected from a plurality of vehicles indicates a common location where drivers will manually control the vehicle instead of allowing autonomous driving control, the ODDs of the vehicles of the network 155 are adjusted so as that they will not (or be less likely) to suggest an autonomous driving operation at the particular location.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Various features, advantages, and embodiments are set forth in the following claims.

What is claimed is:

1. An autonomous vehicle driving system for autonomously controlling a vehicle, the system comprising:
an environment detection system; and
an electronic processor connected to the environment detection system and configured to
detect a behavioral characteristic of a driver of the vehicle, the behavioral characteristic corresponding to a current driving scenario,
determine, via the environment detection system, the current driving scenario in response to detecting the behavioral characteristic, and
adjust an operational design domain of the system based on the determined current driving scenario, the operational design domain being a description of a domain in which the autonomous driving system is designed to operate in.

2. The system of claim 1, wherein determining the current driving scenario includes identifying a feature of the current driving scenario and wherein adjusting the operational domain definition is based on the feature.

3. The system of claim 2, wherein the feature is at least one selected from the group consisting of a location, a time of day, a weather condition, a traffic situation, and a type of road.

4. The system of claim 1, wherein the behavioral characteristic is a facial expression.

5. The system of claim 1, wherein the behavioral characteristic is an adjustment of a speed of the vehicle.

6. The system of claim 1, wherein the behavioral characteristic is a request for the vehicle to be autonomously controlled.

7. The system of claim 1, wherein the driving scenario is a parking scenario.

8. The system of claim 1, wherein the driving scenario is a traffic scenario.

9. A method for operating a vehicle including an autonomous driving system, the method comprising:
detecting a behavioral characteristic of a driver of the vehicle, the behavioral characteristic corresponding to a current driving scenario;
determining, via an environment detection system, the current driving scenario in response to detecting the behavioral characteristic; and
adjusting an operational domain definition of the system based on the determined current driving scenario, the operational design domain being a description of a domain in which the autonomous driving system is designed to operate in.

10. The method of claim 9, wherein determining the current driving scenario includes identifying a feature of the current driving scenario and wherein adjusting the operational domain definition is based on the feature.

11. The method of claim 10, wherein the feature is at least one selected from the group consisting of a location, a time of day, a weather condition, a traffic situation, and a type of road.

12. The method of claim 9, wherein the behavioral characteristic is a facial expression.

13. The method of claim 9, wherein the behavioral characteristic is an adjustment of a speed of the vehicle.

14. The method of claim 9, wherein the behavioral characteristic is a request for the vehicle to be autonomously controlled.

15. The method of claim 9, wherein the driving scenario is a parking scenario.

16. The method of claim 9, wherein the driving scenario is a traffic scenario.
